(19) United States
(12) Patent Application Publication
(10) Pub. No.: US 2004/0072938 A1
(43) Pub. Date: Apr. 15, 2004

(54) Passive damping with platelet reinforced viscoelastic materials

(76) Inventor: Stepan S. Simonian, Torrance, CA (US)

Correspondence Address: TAROLLI, SUNDHEIM, COVELL, TUMMINO, & SZA, 1111 Leader Building, 526 Superior Avenue, Clevevland, OH, 44114-1400, US

(21) Appl. No.: 10/269,697

(22) Filed: Oct. 11, 2002

(51) Int. Cl. C08K 3/08; C08K 3/34

(52) U.S. Cl. 524/439; 524/445; 524/449

(57) ABSTRACT

A vibration damping treatment for damping vibration of a structure includes a viscoelastic material and a plurality of flakes or platelets distributed in the viscoelastic material. The vibration damping material provides damping along more than one axis. An adhesive located on one surface of the viscoelastic material attaches the vibration damping treatment to the structure. Alternately, the vibration damping treatment is applied to the structure as a coating. The width and height dimensions of the flakes or platelets, preferably has a rectangular, square, or irregular cross-section. The viscoelastic material is selected from the group of acrylics, silicones, polymers and elastomers. The flakes or platelets are selected from the group of graphite, hard plastic, ceramic, steel, aluminum, clay, mica, and magnesium. A volume fraction of the flakes is between 5% and 50%. A constraining layer is not required.

### FIELD OF THE INVENTION

The present invention relates to viscoelastic damping treatments, and more particularly to a viscoelastic damping treatment that utilizes platelets or flakes that are dispersed throughout a viscoelastic medium to increase shear strain along multiple axes without the need for a constraining layer.

### BACKGROUND OF THE INVENTION

The presence of unwanted vibration is a common problem in the design of vehicle structures, such as automobiles, trucks, aircraft, ships, and spacecraft, that are subject to dynamic loads. The source of the vibration may be acoustic or may emanate from rotating or reciprocating mechanical devices. As the manufacturing materials for these structures have become lighter and stiffer, the materials have become more susceptible to vibration and noise. Some development effort has been directed toward measuring and improving the intrinsic damping properties of the structural materials. Significant improvements have not been achieved, however, because improved damping requires the selection of materials that compromise the static elastic properties of the structural materials.

Fiber reinforced composites are lightweight substitutes for metals when high specific stiffness, strength and controlled expansion are required. These composites have been particularly effective for commercial and military aircraft. Although the design flexibility of composites provides an effective means for optimizing weight, stress and other mechanical requirements, the composite structures experience undesirable levels of vibration and noise. Vibration frequencies that typically occur in transportation applications are in the low frequency range, typically around ½-200 Hertz. Noise frequencies typically occur between about 20 Hz and 20,000 Hz.

One conventional method for reducing vibration and noise in composite structures involves the application of a viscoelastic material to selected portions of the structure. The viscoelastic material often includes a constraining layer and is typically applied as a coating or a tape. The viscoelastic material dampens vibration and noise by converting structural vibration energy into heat by inducing strain in the viscoelastic material. The viscoelastic material does not support any significant static load but does oppose dynamic disturbances that occur within the structure. During steady-state and transient dynamic conditions, the viscoelastic material suppresses vibratory oscillations in a manner that depends on the geometry of the structure and the compliance of the viscoelastic material.

One conventional viscoelastic material damping treatment includes viscoelastic material and a constraining layer of stiff metal or composite foil, such as aluminum foil. The use of commercially available viscoelastic material materials and application techniques without fiber reinforcement has provided only modest damping of vibration and noise.

One disadvantage that is associated with the use of viscoelastic material damping treatments is the considerable weight that is added to the underlying structure. Conventional viscoelastic material damping treatments do not have acceptable performance or weight efficiency for most aircraft or spacecraft applications. The viscoelastic material is loaded mainly in bulk tension/compression along with minimal localized shear at the constraining layer interfaces. In addition, typical materials used as the constraining layer, such as aluminum, do not have high stiffness to weight ratios as compared with fibers such as graphite.

Viscoelastic material damping treatments with fiber reinforcement, such as the material that is disclosed in U.S. Pat. No. 5, 916,954 which is hereby incorporated by reference, have provided improved damping performance. Fiber length is selected based on the operating temperature and frequency of vibration of the underlying structure. The fibers typically have a length between 1/10 and ¼ inch. The fibers have a circular cross-section and a diameter of approximately 10 microns. The fibers are preferably aligned in the direction of applied stress and may extend outside of the viscoelastic material. These fiber reinforced viscoelastic material damping treatments provide damping only in the direction that the fibers are aligned. Unfortunately, the fiber reinforced viscoelastic material damping treatments provide little or no damping in a direction that is perpendicular to the orientation of the fibers.

### SUMMARY OF THE INVENTION

A vibration damping treatment according to the present invention for damping vibration in a structure includes a viscoelastic material and a plurality of platelets or flakes that are distributed in the viscoelastic material. The platelets or flakes have a stiffness that is greater than the stiffness of the viscoelastic material. The vibration damping treatment provides damping in more than one axial direction.

In other features of the invention, an adhesive located on one side of the viscoelastic material attaches the vibration damping material to the structure. Alternately, the vibration damping treatment is applied as a coating to the structure.

In still other features of the invention, the platelets or flakes have a length, width and height. The width and length dimensions of the platelets or flakes preferably define a rectangular cross-section. The platelets or flakes preferably have a length approximately between 0.002 and 0.2 inches. The platelets or flakes preferably have a width between 0.002 and 0.2 inches. The platelets or flakes preferably have a height between 0.0001 and 0.025 inches.

In yet other features, the viscoelastic material is preferably selected from the group of acrylics, silicones, polymers and elastomers. The platelets or flakes are preferably selected from the group of graphite, hard plastic, ceramic, steel, aluminum, mica, clay, and magnesium. A volume fraction of the platelets or flakes is preferably between 5% and 50%.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A illustrates a viscoelastic damping treatment that includes a constraining layer and a viscoelastic material and that is attached to a structure;

FIG. 1B illustrates the viscoelastic damping treatment of FIG. 1A under a first type of shear stress;

FIG. 1C illustrates a shear stress distribution in the viscoelastic material for the first type of shear stress;

FIG. 2A illustrates the viscoelastic damping treatment under a second type of shear stress;

FIG. 2B illustrates a shear stress distribution in the viscoelastic material for the second type of shear stress;

FIG. 3 illustrates the viscoelastic damping treatment that arises due to bending deformation;

FIG. 4 illustrates a fiber-reinforced viscoelastic damping treatment according to the prior art;

FIG. 5 is a perspective view of a platelet or flake reinforced damping treatment according to the present invention; and

FIG. 6 is a perspective view illustrating an exemplary orientation and shape for the platelets or flakes within the viscoelastic material for a presently preferred embodiment.

### DETAILED DESCRIPTION OF THE INVENTION

The following description of the preferred embodiment(s) is merely exemplary in nature and is in no way intended to limit the invention, its application, or uses.

Viscoelastic damping treatments provide an effective way of providing passive structural damping to control vibration. The vibration control is achieved by converting structural vibration energy into heat by inducing strain in the viscoelastic layer. Significant viscoelastic damping is present in many polymers and other similar materials that are composed of long molecular chains. Damping in the viscoelastic material arises from the relaxation and recovery of the polymer network after it has been subjected to the deformations.

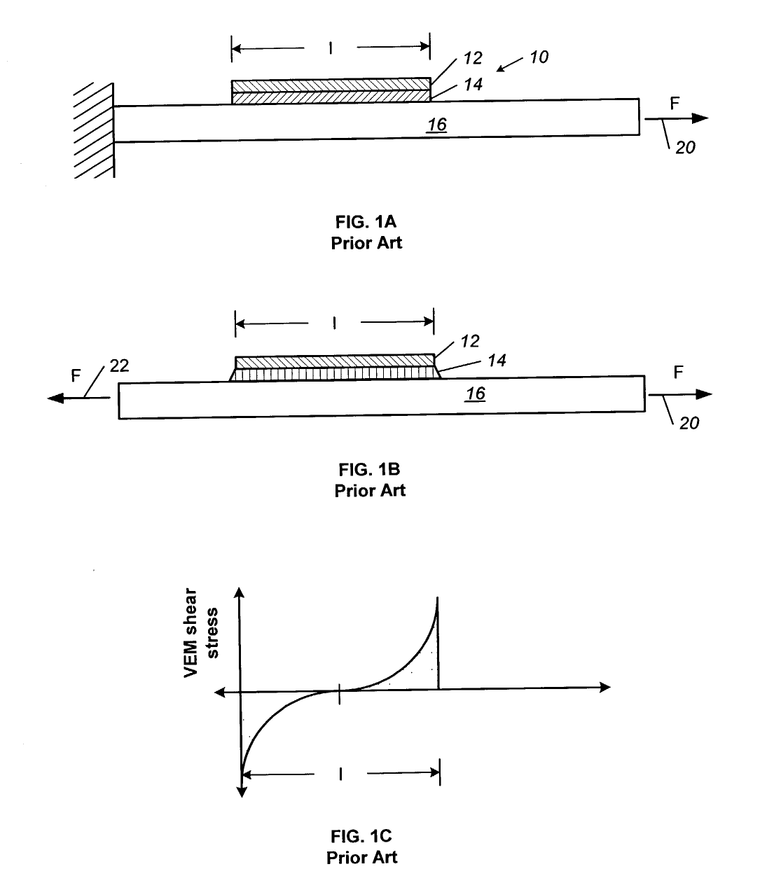

Referring now to FIGS. 1A, 1B and 1C, a viscoelastic damping treatment 10 according to the prior art is illustrated. The viscoelastic damping treatment 10 includes a constraining layer 12 and a viscoelastic material 14. The viscoelastic material 14 is located between the constraining layer 12 and a structure 16. The viscoelastic material 14 is bonded to or otherwise attached to the constraining layer 12. The constraining layer 12 has a stiffness that is greater than the stiffness of the viscoelastic material 14.

The viscoelastic damping treatment 10 is sandwich-like composite that is often manufactured as a tape with a pressure sensitive adhesive (not shown) on one side of the viscoelastic material 14 or as a coating that is applied to the structure 16. The pressure sensitive adhesive bonds the viscoelastic damping treatment 10 to the surface of the vibrating structure 16 to provide damping. When the structure 16 deforms (for example due to opposing forces 20 and 22 in FIG. 1B), the viscoelastic material 14 deforms in shear and provides damping. Because the constraining layer 12 is stiffer than the viscoelastic material 14, structural deformations (vibrations) are transferred to the viscoelastic material 14 at the structure interface as is illustrated in FIG. 1B. At the interface between the viscoelastic material 14 and the constraining layer 12, there is only a very small deformation due to the stiff nature of the constraining layer 12. Therefore, the viscoelastic material 14 is in shear deformation.

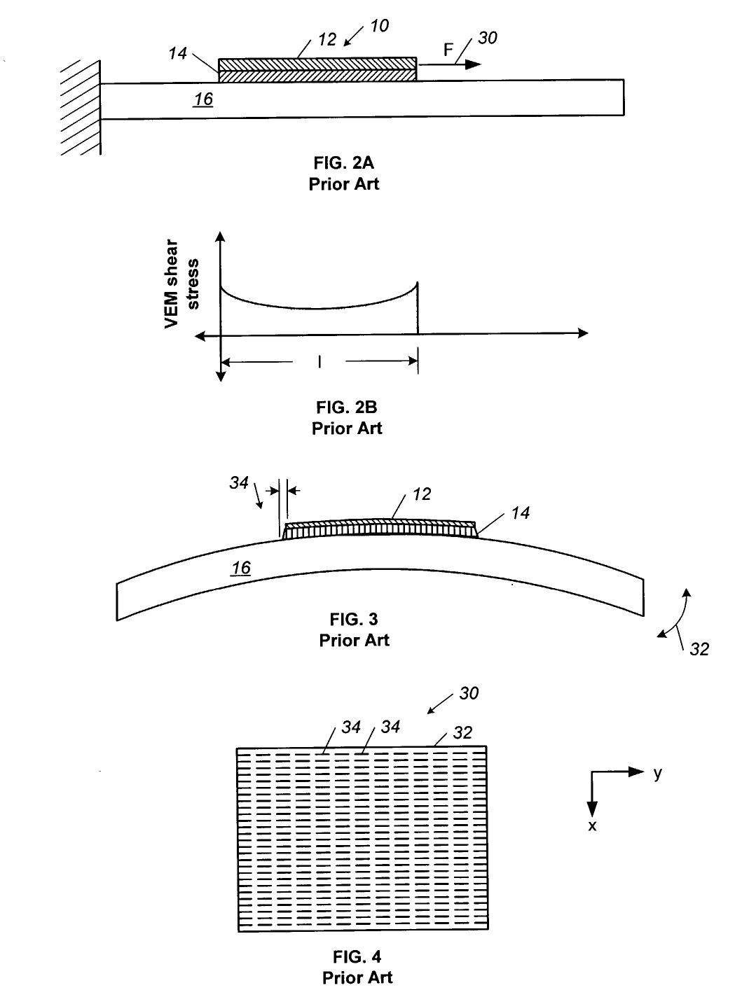

A typical shear stress distribution in the viscoelastic material is depicted in FIG. 1C. The shear stress of the viscoelastic material 14 is illustrated as a function of the length of the viscoelastic material 14 and the constraining layer 12 in FIG. 1C. The shear stress function is related to the following: τₘₐₓ=τ(G_{VEM}, E_{c}A_{c}, EₛAₛ, t_{VEM}, t_{c}, I). G_{VEM} is the shear modulus of the viscoelastic material. E_{c}A_{c} is the axial modulus of the constraining layer 12 multiplied by the cross-sectional area of the constraining layer. EₛAₛ is the axial modulus of the structure multiplied by the cross-sectional area of the structure. t_{VEM} is the thickness of the viscoelastic material 14. t_{c} is the thickness of the constraining layer 12. I is the length of the constraining layer 12. In FIGS. 2A and 2B, the shear stress on the viscoelastic material 14 is illustrated for a force 30.

Referring now to FIG. 3, the structure 16 vibrates as is shown by arrows 32. The viscoelastic material 14 undergoes a shear deformation as indicated at 34. Without the constraining layer 12, the viscoelastic material 14 will be subjected only to tension and compression. In other words, the viscoelastic material 14 is subjected to shear strains when the structure undergoes bending deformation. Damping arises in a deformed polymer by relaxation and recovery of its molecular network and the lost energy is converted into heat.

The amount of achievable damping using the constraining layer 12 depends in part on the length of the constraining layer 12. When the constraining layer 12 is long, the maximum shear strain in the viscoelastic material 14 is concentrated towards the ends of the constraining layer 12 as is depicted in FIG. 1C. Thus, for a given thickness of the viscoelastic material 14 and a given stiffness for the constraining layer 12, there is an optimal length for the constraining layer 12 that will maximize the amount of damping.

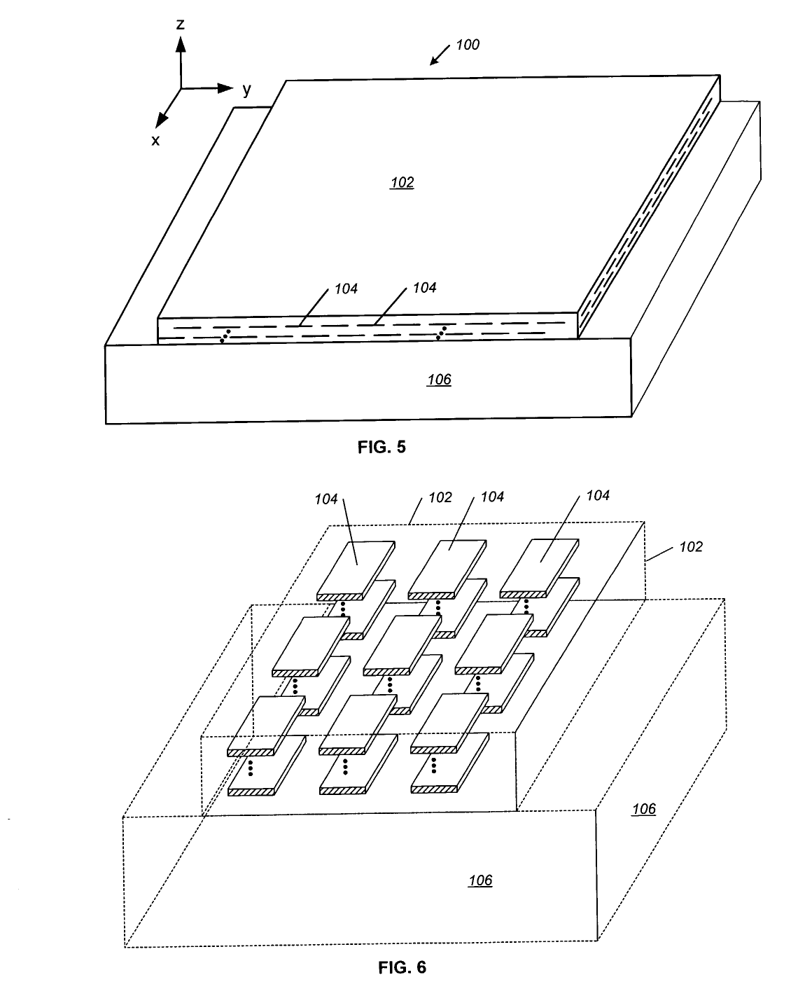

Referring now to FIG. 4, a fiber-reinforced viscoelastic damping treatment 30 is shown. The viscoelastic damping treatment 30 includes viscoelastic material 32 with aligned fibers 34 disposed therein. As discussed above, the viscoelastic damping treatment 30 provides significant damping in the y-axis direction only.

Referring now to FIGS. 5 and 6, a platelet or flake reinforced viscoelastic damping treatment according to the present invention is shown and is generally designated 100. The viscoelastic damping treatment 100 includes a viscoelastic material 102 with a plurality of platelets or flakes 104 that are preferably distributed generally uniformly throughout the viscoelastic material 102. The platelets or flakes 104 have a stiffness that is higher than the stiffness of the viscoelastic material 102. A pressure sensitive adhesive, epoxy or other adhesives may be used to attach one side of the viscoelastic damping treatment 100 to a structure 106. While a constraining layer is no longer required, a constraining layer may be added if desired. The viscoelastic damping treatment 100 may also be applied to the structure 106 as a coating.

In a presently preferred embodiment, the platelets or flakes 104 have length, width and height dimensions. The width and length of the platelets or flakes preferably define a rectangular or square cross-section although other cross-sections are contemplated. For example, mica flakes have an irregular cross-section. The platelets or flakes 104 have a length that is preferably between 0.002 and 0.2 inches. The platelets or flakes 104 have a height that is preferably between 0.0001 and 0.025 inches. The platelets or flakes 104 have a width that is preferably between 0.002 and 0.2 inches. Preferably, the viscoelastic material 102 is selected from the group of acrylics, silicones, polymers and elastomers. The platelets or flakes 104 are preferably selected from the group of graphite, hard plastic, ceramic, steel, aluminum, mica, clay, and magnesium. A volume fraction of the platelets or flakes 104 is between 5% and 50%.

The platelet reinforced viscoelastic damping treatment according to the invention provides damping in more than one axial direction (e.g. in the x and y axis). Significant cost and weight improvement is also provided as compared with fiber-reinforced or constraining layer viscoelastic material damping treatments.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A vibration damping treatment for damping vibration of a structure, comprising:
a viscoelastic material; and
a plurality of platelets distributed in said viscoelastic material, wherein said platelets have a greater stiffness than said viscoelastic material and said vibration damping treatment provides damping along more than one axis.

2. The vibration damping treatment of claim 1 further comprising:
an adhesive located on one surface of said viscoelastic material for attaching said vibration damping treatment to said structure.

3. The vibration damping treatment of claim 1 wherein said vibration damping treatment is applied to said structure as a coating.

4. The vibration damping treatment of claim 1 wherein said platelets have an irregular shaped cross-section.

5. The vibration damping treatment of claim 1 wherein said platelets have a length, width and height and wherein said width and length define a rectangular cross-section.

6. The vibration damping treatment of claim 5 wherein said platelets have a length between 0.002 and 0.2 inches.

7. The vibration damping treatment of claim 1 wherein said viscoelastic material is selected from the group of acrylics, silicones, polymers and elastomers.

8. The vibration damping treatment of claim 1 wherein said platelets are selected from the group of graphite, hard plastic, ceramic, steel, aluminum, mica, clay and magnesium.

9. The vibration damping treatment of claim 1 wherein a volume fraction of said platelets is between 5% and 50%.

10. The vibration damping treatment of claim 1 wherein said platelets have a width between 0.002 and 0.2 inches.

11. The vibration damping treatment of claim 1 wherein said platelets have a height between 0.0001 and 0.025 inches.

12. A vibration damping treatment for damping vibration of a structure, comprising:
a viscoelastic material; and
a plurality of platelets distributed in said viscoelastic material, wherein said platelets have a rectangular cross-section and said vibration damping material damps vibration in said structure along more than one axis.

13. The vibration damping treatment of claim 12 wherein said platelets have a length, width and height and wherein said width and length dimensions of said platelets define a rectangular cross-section.

14. The vibration damping treatment of claim 12 wherein said viscoelastic material is selected from the group of acrylics, silicones, polymers and elastomers.

15. The vibration damping treatment of claim 12 wherein said platelets are selected from the group of graphite, hard plastic, ceramic, steel, aluminum, mica, clay and magnesium.

16. The vibration damping treatment of claim 12 wherein a volume fraction of said platelets is between 5% and 50%.

17. The vibration damping treatment of claim 12 wherein said platelets have a height between 0.0001 and 0.025 inches and a width between 0.002 and 0.2 inches.

18. The vibration damping treatment of claim 12 wherein said platelets have an irregular shaped cross-section.

19. A method of damping vibration in a structure, comprising:
providing a viscoelastic material;
distributing a plurality of platelets having a stiffness that is greater than said viscoelastic material in said viscoelastic material to create a platelet-reinforced viscoelastic material; and
attaching said platelet-reinforced viscoelastic material to said structure, wherein said platelet-reinforced viscoelastic material provides damping along more than one axis.

20. The method of claim 19 further comprising:
an adhesive located on one surface of said viscoelastic material for attaching said platelet-reinforced viscoelastic material to said structure.

21. The method of claim 19 further comprising the step of applying said platelet-reinforced viscoelastic material to said structure as a coating.

22. The method of claim 19 wherein said platelets have a length, width and height, and wherein said width and length dimensions of said platelets define a rectangular cross-section.

23. The method of claim 19 wherein said platelets have a length between 0.002 and 0.2 inches.

24. The method of claim 19 further comprising the step of selecting said viscoelastic material from the group of acrylics, silicones, polymers and elastomers.

25. The method of claim 19 further comprising the step of selecting said flakes from the group of graphite, hard plastic, ceramic, steel, aluminum, mica, clay and magnesium.

26. The method of claim 19 further comprising the step of setting a volume fraction of said flakes between 5% and 50%.
